(19) United States
(12) Patent Application Publication
(10) Pub. No.: US 2007/0172197 A1
(43) Pub. Date: Jul. 26, 2007

(54) REALTIME PLAYBACK METHOD FOR VIDEO RECORDING SYSTEM

(75) Inventors: Wu Hsien Chuang, Taipei City (TW); Chen Cheng Chiang, Taichung City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/624,679

(22) Filed: Jan. 18, 2007

(30) Foreign Application Priority Data
Jan. 20, 2006 (TW) TW95102198

(51) Int. Cl. H04N 5/91

(52) U.S. Cl. 386/83

(57) ABSTRACT

The invention provides a realtime playback method for a digital video recording system, comprising receiving input video data, saving the input video data as buffered data, and, when the digital video recording system operates in a realtime playback mode, converting the buffered data to the output video data.

### BACKGROUND OF THE INVENTION

1. Field of the Invention

The invention relates to video recording systems, and more particularly to realtime playback methods and systems for replaying video data received by a video recording system.

2. Description of the Related Art

A recording system, such as a DVD recorder, typically utilized for recording video data, receives input video data from an antenna or a cable, converts the input video data to output video data, and displays the output data through an output device, such as a TV or a home theatre system. Users can configure the video recording settings.

Fig. shows a block diagram of a conventional recording system comprising video data input unit 11, output unit 12, controller 13, recorder 14, player 15, second memory unit 16, and storage unit 17.

Video data input unit 11 receives and converts video data AVIN into first video data DAV. Output unit 12 outputs video data AVOUT. Recorder 14 comprises a first memory unit 141 receiving and buffering the first video data DAV as buffered data. Second memory unit 16 coupled to recorder 14 receives the buffered data. Player 15 coupled to second memory unit 16 retrieves the buffered data and output the buffered data to output unit 12. Storage unit 17 can permanently store the buffered data.

Recording system 10 can operate in the following modes: a relay mode where the video data AVIN is immediately displayed; a recording mode where the video data AVIN is recorded in storage unit 17; a time shift mode where the video data AVIN is buffered for later display; and a replay mode for replaying video data previously stored in storage unit 17.

In the relay mode, controller 13 directs output unit 12 to convert the input video data to the output video data. Output unit 12 may directly convert the input video data AVIN to the output video data AVOUT, or convert first video data DAV to the output video data AVOUT.

In the recording mode, controller 13 routes the buffered data to second memory unit 16, reads and stores the buffered video data from second memory unit 16 to storage unit 17. Controller 13 can direct output unit 12 to convert realtime video data from video data input unit 11 or convert the buffered data read by player 15 from second memory unit 16.

In the time shift mode, controller 13 routes buffered data to second memory unit 16, directs player 15 to retrieve the buffered data from second memory unit 16 for transmission to output unit 12, and directs output unit 12 to convert the buffered data to the output video data AVOUT for output.

In the replaying mode, controller 13 converts data in storage unit 17 to a digital playable format for loading in second memory unit 16 and output by player 15 and output unit 12.

The drawback of the conventional recording system is that video data buffering or storage in the recording mode or the time shift mode is disabled until the recording system is switched to a corresponding mode. Occasionally, video with desirable and unpredictable special events (such as a home run in a baseball game) is broadcast and received in real time. It is difficult to switch to a proper mode for recording video of such desired events.

### BRIEF SUMMARY OF THE INVENTION

A detailed description is given in the following embodiments with reference to the accompanying drawings.

An exemplary embodiment of a realtime playback method for a video recording system is provided. The method enables a recording system to operate in a realtime playback mode in addition to those conventional modes.

Input video data is received through the recording system and saved as buffered data. When the video recording system operates in the realtime playback mode, the buffered data is converted to output video data. Thus, video data is continuously buffered and may be replayed as required.

An exemplary embodiment of a video recording system is operable in at least a relay mode or a realtime playback mode to continuously receive input video data and provide output video data is provided. The system comprises a recorder, a second memory unit, a player, and a controller. The recorder comprises a first memory unit continuously saving the input video data as buffered data. The second memory unit is coupled to the recorder. The player is coupled to the second memory unit. The controller directs the video recording system to convert the input video data into the output video data when the video recording system operates in the relay mode, and, when the video recording system operates in the realtime playback mode, routes the buffered video data to the second memory unit and directs the player to retrieve the buffered video data from the second memory unit as the output video data.

### BRIEF DESCRIPTION OF THE DRAWINGS

The invention can be more fully understood by reading the subsequent detailed description and examples with references made to the accompanying drawings, wherein:

FIG. 1 is a block diagram of a conventional recording system 10;

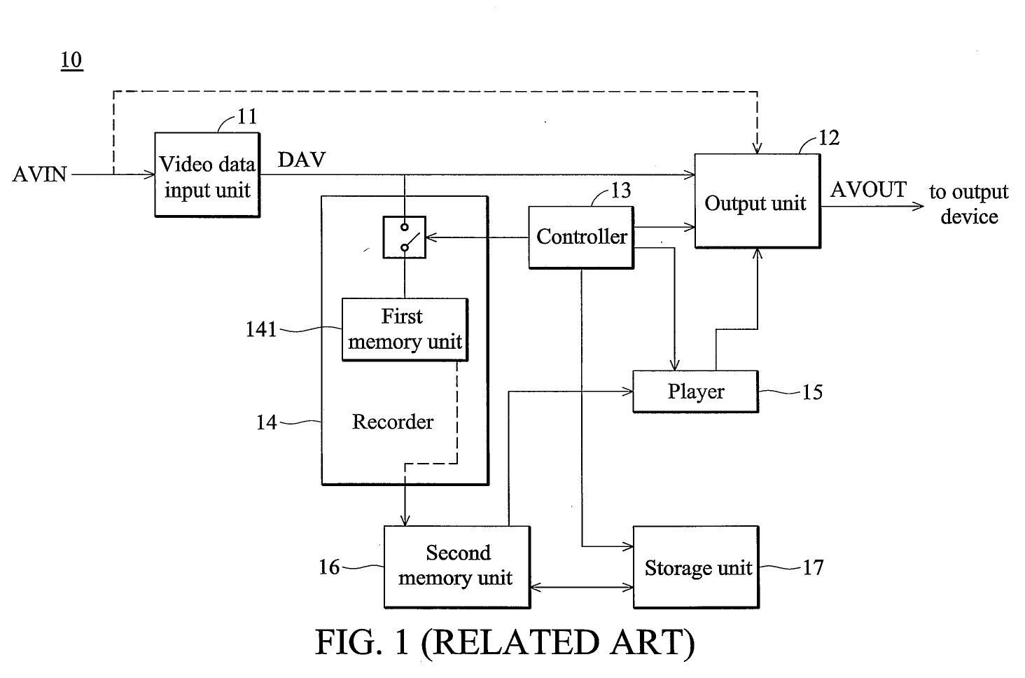

FIG. 2 is a block diagram of an exemplary embodiment of a recording system 20;

FIG. 3A is a schematic view of an exemplary embodiment of a first memory unit 241; and

FIGS. 3B˜3D are schematic diagrams of first memory unit 241 with five cyclic buffer cells.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

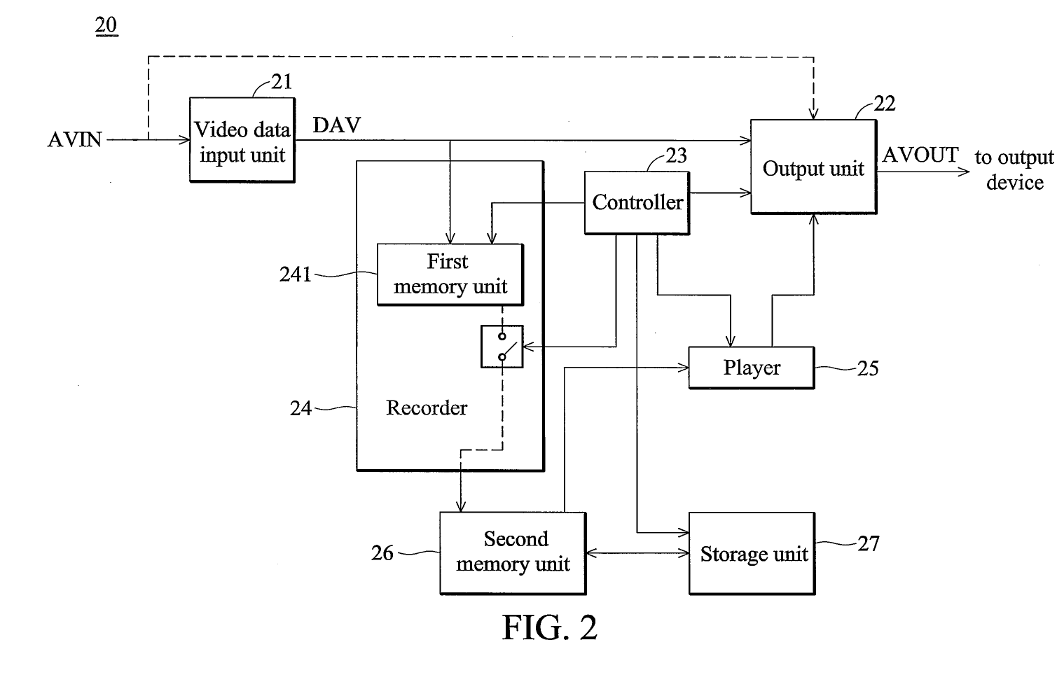

With reference to FIG. 2, recording system 20 comprises video data input unit 21, output unit 22, controller 23, recorder 24, player 25, second memory unit 26, and storage unit 27.

Video data input unit 21 receives and converts input video data AVIN to first video data (such as DAV). Output unit 22 provides output video data AVOUT. Recorder 24 comprises a first memory unit 241 for receiving and storing first video data (such as DAV) as the buffered data. Second memory unit 26 coupled to recorder 24 receives the buffered data. Player 25 coupled to second memory unit 26 reads and transmits the buffered data to output unit 22. Storage unit 27 may permanently store the buffered data.

In addition to the relay, recording, time shift, and replay modes, recording system 20 can operate in a novel realtime playback mode. Recording system 20 may act as recording system 10 in the recording, time shift, and replay mode. Thus, detailed description thereof is omitted.

When recording system 20 operates in the relay mode, controller 23 directs output unit 22 to convert the input video data into output video data. Output unit 22 can directly converts the input video data AVIN into video data AVOUT, or convert the first video data (such as DAV) to video data AVOUT.

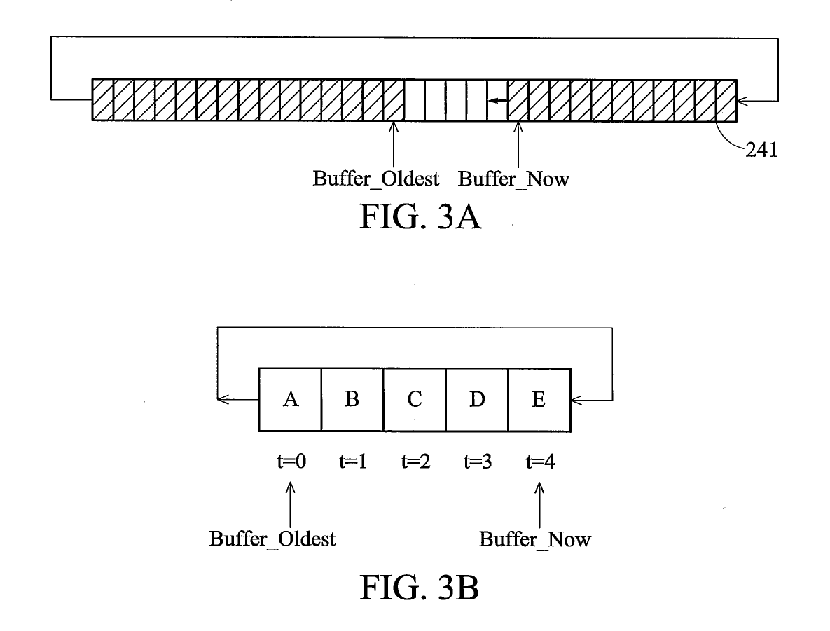

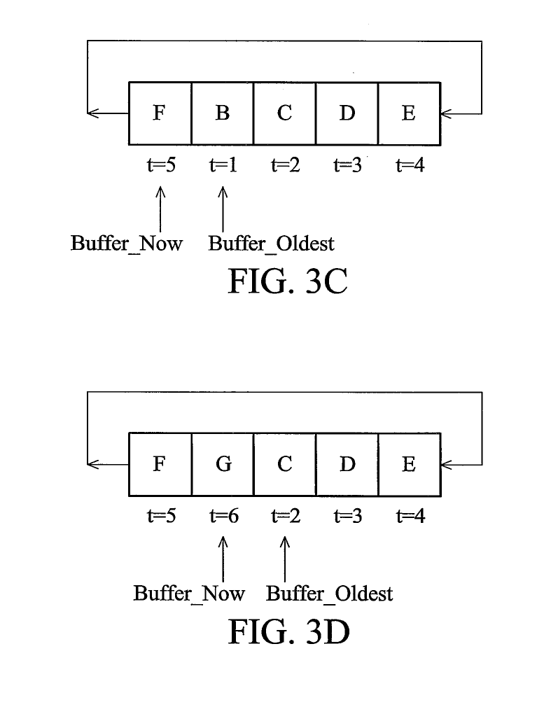

What makes recording system 20 novel in the relay mode is that recorder 24 continuously receives and stores the first video data (such as DAV) as the buffered data in first memory unit 241. With reference to FIG. 3A, first memory unit 241 comprises a cyclic buffer with a plurality of buffer cells, each can store certain bits of video data. First memory unit 241 comprises pointers Buffer_Now and Buffer_oldest. Pointer Buffer_oldest targets to the oldest data in first memory unit 241, while pointer Buffer_Now targets to the newest data in first memory unit 241. When the buffer cell targeted by pointer Buffer_Now approaches the buffer cell targeted by pointer Buffer_oldest, the oldest buffered data targeted by pointer Buffer_oldest is discarded in first memory unit 241, and the value of pointer Buffer_oldest is increased by one. Thus first memory unit 241 can be recycled for buffering newest video data. With reference to FIG. 3B, data A, B, C, D, and E is in turn stored during t=0˜t=4. As a result, pointer Buffer_oldest targets to a cell labeled with t=0, and pointer Buffer_Now targets to another cell labeled with t=4. As shown in FIG. 3C, when t=5, first memory unit 241 has new data F at t=5 replace data A in the cell previously targeted by pointer Buffer_oldest. As a result, cell labeled with t=1 preserves the oldest data. The value of pointer Buffer_oldest is increased by one and targeted to the cell labeled with t=1. Pointer Buffer_Now targets to the newest data in the location of t=5. As shown in FIG. 3D, when t=6, first memory unit 241 has new data G at t=6 replace data B in the cell previously targeted by pointer Buffer_oldest. As a result, cell labeled with t=2 preserves the oldest data. The value of pointer Buffer_oldest is increased by one and targeted to the cell labeled with t=2. Pointer Buffer_Now is increased by one and targeted to the newest data in the location of t=6.

When recording system 20 operates in the relay mode, controller 23 routes the buffered video data in first memory unit 241 to second memory unit 26, comprising data in the cell targeted by pointer Buffer_Now as well as data in one or more cell between those targeted by pointers Buffer_Now and Buffer_oldest. Controller 23 may direct output unit 22 to convert the buffered data retrieved by player 25 from second memory unit 26 to the output video data. Controller 23 may direct output unit 22 to simultaneously convert realtime video data from video data input unit 21 and output the realtime video data and replayed video data to prevent from missing any desired scene therein. The realtime video data and replayed video data may be simultaneously output in the picture in picture (PIP) format. Additionally, controller 23 directs storage unit 27 to store a copy of the buffered data for future replay.

With the described embodiment, old video data may be replayed during playback of recently received new video data. How long the old video can be reserved for replay depends on the sizes of the first memory unit and the number of buffer cells assigned for video data buffering when the recording system operates in the relay mode. Users can simultaneously observe realtime received video data and replayed old video data, or buffered the received video data for future playback.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A realtime playback method for a video recording system, comprising:
receiving input video data through the recording system and saving the input video data as buffered data; and
when the video recording system operates in a realtime playback mode, converting the buffered data to output video data.

2. The method as claimed in claim 1, wherein the input video data is converted into first video data and saved as the buffered data.

3. The method as claimed in claim 1, further comprising when the video recording system operates in the realtime playback mode, combining the buffered data and the input video data to form the output video data.

4. The method as claimed in claim 3, wherein, after the buffered data and the input video data are combined into the output video data, the output video data conforms to a picture in picture (PIP) format.

5. The method as claimed in claim 1, further comprising when the video recording system operates in the realtime playback mode, saving a copy of the buffered data to a storage device.

6. A video recording system, operable in at least a relay mode or a realtime playback mode to continuously receive input video data and provide output video data, comprising:
a recorder comprising a first memory unit continuously saving the input video data as buffered data;
a second memory unit coupled to the recorder;
a player coupled to the second memory units; and
a controller directing the video recording system to convert the input video data into the output video data when the video recording system operates in the relay mode, and, when the video recording system operates in the realtime playback mode, routing the buffered video data to the second memory unit and directing the player to retrieve the buffered video data from the second memory unit as the output video data.

7. The system as claimed in claim 6, further comprising:
a video input unit receiving and converting the input video data into first video data and transmitting the first video data to the recorder which saves the first video data as the buffered data.

8. The system as claimed in claim 6, further comprising:
an output unit coupled to the player and the controller and receiving the input video data, wherein when the video recording system operates in the relay mode, the controller directs the output unit to convert the input video data into the output video data, and, when the video recording system operates in the realtime playback mode, the controller directs the player to display the output video data through the output unit.

9. The system as claimed in claim 7, further comprising:
an output unit coupled to the player and the controller and receiving the input video data, wherein when the video recording system operates in the relay mode, the controller directs the output unit to convert the first video data into the output video data, and, when the video recording system operates in the realtime playback mode, the controller directs the player to display the output video data through the output unit.

10. The system as claimed in claim 6, wherein the first memory unit further comprises a cyclic buffer.

11. The system as claimed in claim 6, further comprising:
a storage unit storing a copy of video data stored in the second memory unit.

12. The system as claimed in claim 11, wherein, when the video recording system operates in the realtime playback mode, the controller directs the storage unit to store a copy of the buffered data.

13. The system as claimed in claim 6, wherein when the video recording system operates in the realtime playback mode, the controller further combines the buffered data and the input video data to form the output video data.

14. The system as claimed in claim 13, wherein the output unit combines the buffered data and the input video data into the output video data in picture in picture (PIP) format.
